(19) United States
(12) Patent Application Publication
(10) Pub. No.: US 2025/0361878 A1
(43) Pub. Date: Nov. 27, 2025

(54) BLOWER TOOL AND RESONATOR DEVICE

(71) Applicant: Milwaukee Electric Tool Corporation, Brookfield, WI (US)

(72) Inventors: Sourav Sens, Brookfield, WI (US); Nathaniel A. Herrera, Oak Creek, WI (US); Jonathan Paul, Brookfield, WI (US); Marcus T. Jenkins, Wauwatosa, WI (US); Pranjal Kumar, Brookfield, WI (US); Adam F. Czerwonka, Mukwonago, WI (US); Beth E. Cholst, Wauwatosa, WI (US); Harry T. Ward, Mequon, WI (US); Andrew Medeiros-Nicholson, Brookfield, WI (US); Hayden Huttula, Brookfield, WI (US)

(21) Appl. No.: 19/217,726

(22) Filed: May 23, 2025

Related U.S. Application Data
(60) Provisional application No. 63/651,283, filed on May 23, 2024.
(60) Provisional application No. 63/664,236, filed on Jun. 26, 2024.

(51) Int. Cl. F04D 29/66; A01G 20/47; F04D 19/00

(52) U.S. Cl. CPC F04D 29/665; F04D 29/664; A01G 20/47; F04D 19/002

(57) ABSTRACT

A blower is provided, the blower including a conduit extending along a flowpath extending between an inlet portion and an outlet portion. An airflow generation assembly is positioned between the inlet portion and the outlet portion. The airflow generation assembly is configured to induce a flow of air along the flowpath from the inlet portion through the outlet portion. A muffler assembly is coupled to the inlet portion and includes a muffler wall and a mount member extending from the inlet portion to the muffler wall to form an inlet gap therebetween.

### PRIORITY STATEMENT

The present application claims the benefit of priority to U.S. provisional patent application No. 63/664,236, filed Jun. 26, 2024, titled “BLOWER TOOL AND RESONATOR DEVICE”, and to U.S. provisional patent application No. 63/651,283, filed May 23, 2024, titled “BLOWERS WITH NOISE REDUCTION FEATURES”, the disclosures of which are incorporated by reference herein in their entireties.

### FIELD

The present disclosure relates generally to outdoor tools such as blowers, and more particularly to improved blower features which provide noise reduction.

### BACKGROUND

Outdoor tools such as blowers are commonly used to concentrate debris, e.g., leaves, using a blowing function. Blowers being powered by a battery power source are particularly desirable due to their portability. However, improvements in various aspects of blowers are desired.

In particular, one issue with many power tools, including blowers, is the noise generated during operation. Such noise may emanate from engines, fan blades, and other moving and stationary components of the power tools. While quieter power tools can be produced simply by reducing the power and performance level of the power tool, the resulting product is not desirable to the customer due to the lack of performance.

Accordingly, improved blowers are desired in the art. In particular, a blower which addresses one or more of the above-described issues would be advantageous.

### BRIEF DESCRIPTION

Aspects and advantages of the invention will be set forth in part in the following description, or may be obvious from the description, or may be learned through practice of the invention.

An aspect of the present disclosure is directed to a blower. A conduit extends along a flowpath extending between an inlet portion and an outlet portion. An airflow generation assembly is positioned between the inlet portion and the outlet portion. The airflow generation assembly is configured to induce a flow of air along the flowpath from the inlet portion through the outlet portion. A muffler assembly is coupled to the inlet portion. The muffler assembly includes a muffler wall and a mount member extending from the inlet portion to the muffler wall to form an inlet gap therebetween.

Another aspect of the present disclosure is directed to a blower. A conduit extends along a flowpath extending between an inlet portion and an outlet portion. An airflow generation assembly is positioned between the inlet portion and the outlet portion. The airflow generation assembly is configured to induce a flow of air along the flowpath from the inlet portion through the outlet portion. The inlet portion includes a resonator device having a plurality of passages extending in fluid communication from the flowpath.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a side view of an exemplary embodiment of a blower in accordance with aspects of the present disclosure;

FIG. 2 provides a cross-sectional side view of an exemplary embodiment of a blower in accordance with aspects of the present disclosure;

FIG. 3 provides an exemplary view of a user holding an exemplary embodiment of the blower in accordance with aspects of the present disclosure;

FIG. 4 provides a perspective view of an exemplary embodiment of the blower in accordance with aspects of the present disclosure;

FIG. 5 provides a partially transparent perspective view of the exemplary embodiment of the blower of FIG. 4 in accordance with aspects of the present disclosure;

FIG. 6 provides a partially transparent perspective view of an exemplary embodiment of the blower in accordance with aspects of the present disclosure;

FIG. 7 provides a flowpath cross-sectional view of an exemplary embodiment of the blower in accordance with aspects of the present disclosure;

FIG. 8A provides an exemplary embodiment of a resonator structure in accordance with aspects of the present disclosure;

FIG. 8B provides an exemplary embodiment of a resonator structure in accordance with aspects of the present disclosure;

FIG. 8C provides an exemplary embodiment of a resonator structure in accordance with aspects of the present disclosure;

FIG. 8D provides an exemplary embodiment of a resonator structure in accordance with aspects of the present disclosure;

FIG. 8E provides an exemplary embodiment of a resonator structure in accordance with aspects of the present disclosure;

FIG. 8F provides an exemplary embodiment of a resonator structure in accordance with aspects of the present disclosure;

FIG. 9 provides a cutaway view of an exemplary embodiment of the blower in accordance with aspects of the present disclosure;

FIG. 10 provides a perspective view of an exemplary embodiment of a blower in accordance with aspects of the present disclosure;

FIG. 11 provides a perspective view of an exemplary embodiment of the blower of FIG. 10 in accordance with aspects of the present disclosure;

FIG. 12 provides a cutaway view of an exemplary embodiment of the blower of FIG. 11 in accordance with aspects of the present disclosure;

FIG. 13 provides a perspective view of an exemplary embodiment of the blower in accordance with aspects of the present disclosure;

FIG. 14 provides a cutaway view of an exemplary embodiment of the blower of FIG. 13 in accordance with aspects of the present disclosure;

FIG. 15 provides a partially transparent view of an exemplary embodiment of a muffler assembly in accordance with aspects of the present disclosure;

FIG. 16 provides a perspective view of a portion of an embodiment of a muffler assembly in accordance with aspects of the present disclosure; and

FIG. 17 provides a perspective view of a portion of an embodiment of a muffler assembly in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure addresses one or more of the above-described issues by providing blowers with improved features as shown and described herein.

Embodiments of axial, centrifugal, backpack-mounted, or walk-behind blowers are provided that are configured to reduce or attenuate sound by absorbing, reflecting, bending, or resonating from sound waves or flow directed at a resonance device and structure.

Resonance devices and structures depicted and described herein include axially or radially extending resonator passages or chambers positioned relative to an airflow generation assembly (e.g., positioned relative to a fan or motor). Various embodiments include axially and/or radially extending resonator passages or chambers arranged around a perimeter of an inlet portion of the blower, circumferentially arranged around the airflow generation assembly, or spaced apart from the inlet portion (e.g., positioned upstream of the airflow generation assembly or positioned upstream of the inlet portion), or combinations thereof. In some embodiments, resonance devices and structures provided herein include single or multi-layer walls including radially-extending passages or chambers.

In still various embodiments, resonance devices and structures provided herein include metamaterials configured to attenuate, reflect, absorb, or deflect sound waves generated from the airflow generation assembly.

Various embodiments of resonance devices and structures may be configured to target desired frequencies relative to various desired speeds of the motor or fan assembly. For instance, target frequencies may include motor rotational frequency, fan blade pass frequency, or multiples thereof (e.g., from 1× up to 6× or more of motor RPM/60 or blade pass frequency), or desired structural modal frequencies. Still various resonance passages or chambers may be tuned to quarter wavelength or half wavelength of the target frequency to attenuate sound perceived by a user within a user perception zone (e.g., a cone of silence).

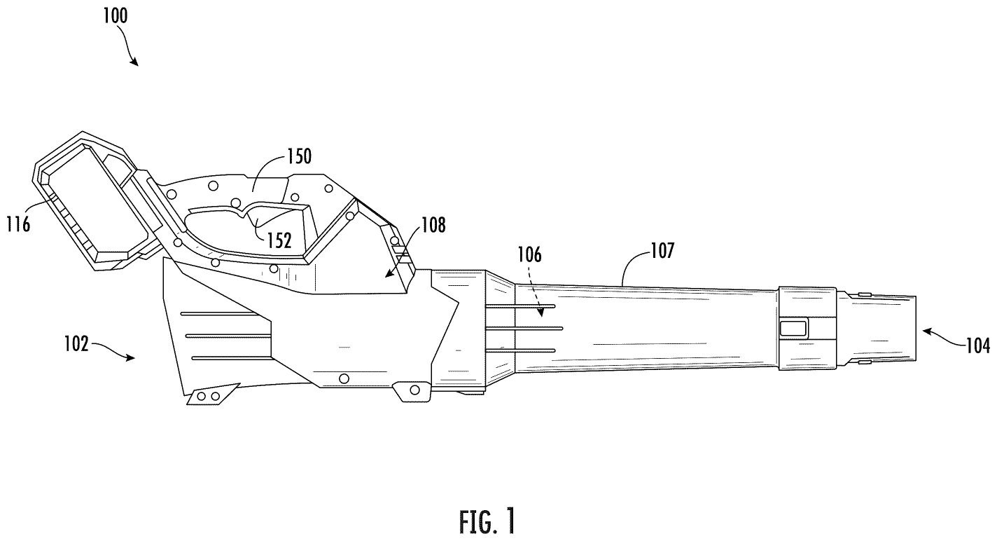

Referring now to the drawings, FIG. 1 illustrates a side view of a blower 100 in accordance with an exemplary embodiment. The blower 100 is configured to generate airflow along an airflow conduit 106 extending between an air inlet 102 and an air outlet 104 of the blower 100. The airflow generating conduit 106 may include a blower tube 107 as shown.

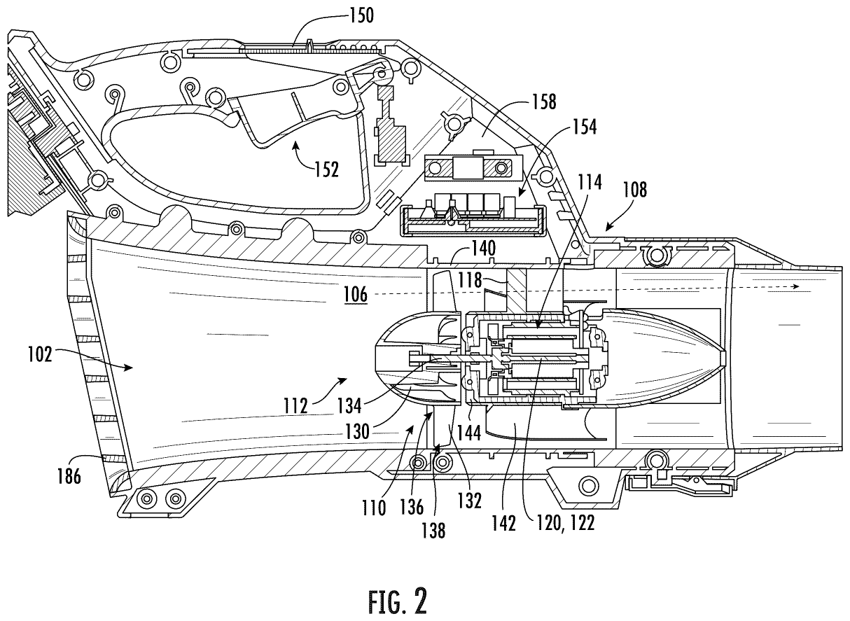

As illustrated in FIGS. 1 and 2, a blower housing 108 may at least partially enclose components of the blower 100 such as an airflow generation assembly 110 including a fan 112 and a motor 114 that drives the fan 112, as well as various other components. Power to operate the airflow generation assembly 110 may be provided by a suitable power source such as one or more batteries 116 removably coupled to the blower housing 108. The blower 100 may be provided as a standard handheld blower having a cordless battery powered power source. In other embodiments, the blower may include a corded electric power source and/or a gas power source.

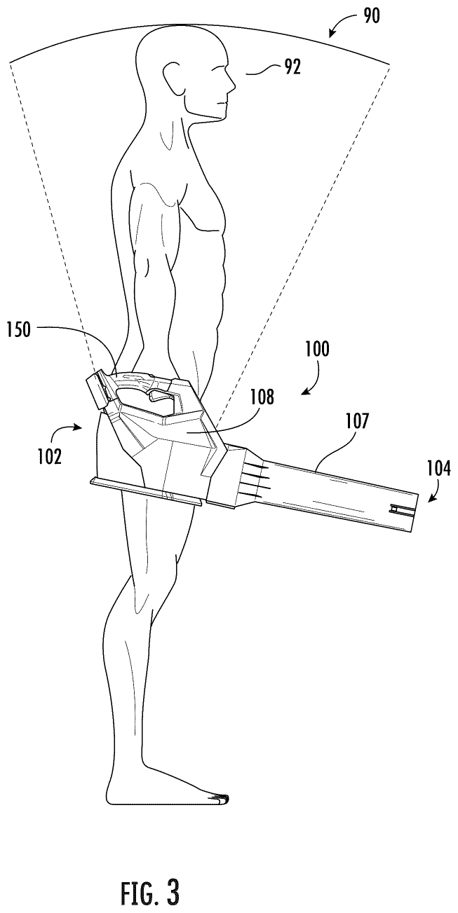

Additionally, a blower in accordance with the present disclosure may be a handheld blower as shown, or may be provided as a backpack blower (such as, for example, illustrated in FIG. 3) adapted to be worn on a user's back.

Still referring to FIGS. 1 and 2, the airflow generation assembly 110 may have an axial configuration including an axial fan 112. The motor 114 may be mounted within the housing 108. For instance, the blower housing 108 may include a motor mount 118 configured to support the motor 114 between the air inlet 102 and the air outlet 104. The motor mount 118 may include a stator vane assembly 142 having an airfoil structure configured to condition the flow of air through the conduit 106, such as across the motor mount 118. The motor mount 118 extends from a motor casing 144 surrounding the motor 114. The motor 114 is oriented along a motor axis 120. The motor axis 120 coincides with a central axis of the airflow conduit 106. Rotation of the motor 114 causes rotation of a primary motor shaft 122 extending along the motor axis 120. The motor shaft 122 is coupled to the fan 112. In this manner, rotation of the motor shaft 122 causes rotation of the fan 112.

The fan 112 includes a hub 130 and a plurality of blades 132. The hub 130 may have a generally circular cross-sectional shape and may extend along the motor axis 120. The motor shaft 122 is coupled to the hub 130 and/or a fan drive shaft 134 to facilitate transmission of rotation from the motor 120 to the hub 130 or the fan drive shaft 134 and ultimately to the blades 132. As such, the airflow generation assembly 110 positioned between the inlet portion 102 and the outlet portion 104 is configured to induce a flow of air along the conduit 106 from the inlet portion 102 through the outlet portion 104.

The blades 132 extend radially away from the hub 130. Each blade 132 extends from a root 136 to a tip 138 and has a first face and a second face opposite the first face. For instance, the first face may form a pressure side and the second face may form a suction side as may generally be understood regarding airfoils. The root 136 is connected to the hub 130 of the fan 112. The tip 138 extends radially toward a shroud 140 circumferentially surrounding the blades 132.

A stator vane assembly 142 extends radially from the motor casing 144 toward the shroud 140 surrounding the motor casing 144. The stator vane assembly 142 includes a plurality of stationary airfoils configured to condition flow of air through the conduit 106.

Referring still to FIGS. 1-2, the blower 100 includes a handle 150 at which a user grips the blower and a trigger 152 configured to selectively operate the airflow generation assembly 110. The blower housing 108 includes a controller 154 operably coupled to the trigger 152 and articulatable components of the blower 100, such as the airflow generation assembly 110. The blower housing 108 includes a plenum 158 at which the controller 154 may be positioned. The plenum 158 may additionally, or alternatively, include a resonance structure, such as further described herein.

Plenum 158 may generally be positioned radially outward of the conduit 106, airflow generation assembly 110, or portions thereof. For instance, plenum 158 may generally be positioned radially between the airflow generation assembly 110 and the handle 150. In still various instances, plenum 158 may generally be positioned radially between the conduit 106 and the handle 150.

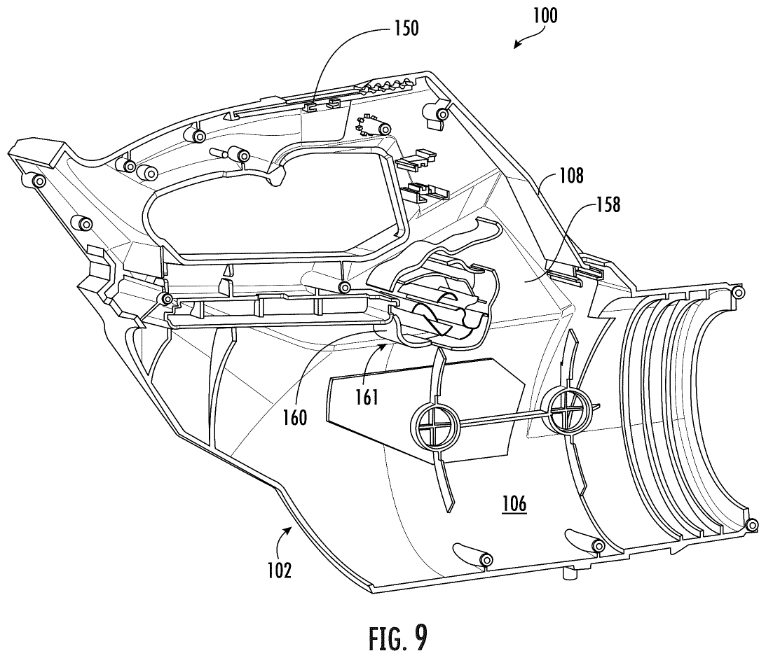

Referring to FIG. 3, resonator devices and structures provided herein facilitate attenuating sound and noise from propagating to a user 92 within a user perception zone 90 when the user 92 holds the blower 100 at the handle 150. Referring briefly to FIG. 9, a perspective cross sectional view of a portion of the blower housing 108 depicts a resonator structure 160 positioned in the plenum 158. In some embodiments, at least a portion of the resonator structure 160 may extend into the conduit 106, such as through an opening 161 extending from the plenum 158 to the inlet portion 102. Blower housing 108, or portions thereof, such as handle 150, may be formed of one or more portions, such as halves. Resonator structure 160 may be included in respective portions of the blower housing 108. Resonator structure 160 forms passageways configured to absorb sound pressure generated at the conduit 106 from the airflow generation assembly 110.

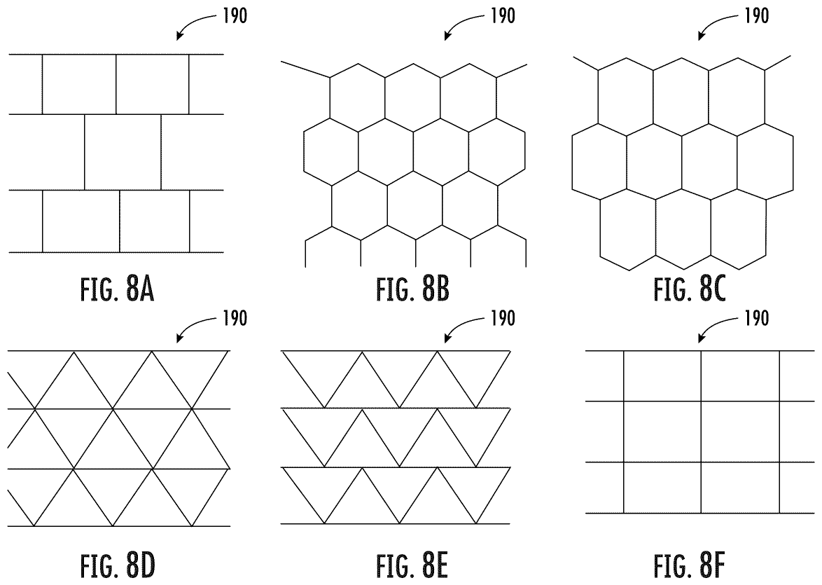

In various embodiments, resonator structure 160 includes a metamaterial configured to attenuate sound pressure. The resonator structure 160 may include a labyrinthine wave structure, such as depicted in FIG. 9. Referring to FIGS. 8A-8F, in other embodiments, resonator structure 160 may include a plurality of polygonal cells 190. The plurality of polygonal cells 190 may form structured, unstructured, or organic cavities configured to absorb sound pressure waves generated from the airflow generation assembly 110. Positioning the resonator structure 160 in the plenum 158 corresponding to the user perception zone 90 facilitates reduction of noise perceived by the user 92, such as depicted in FIG. 3.

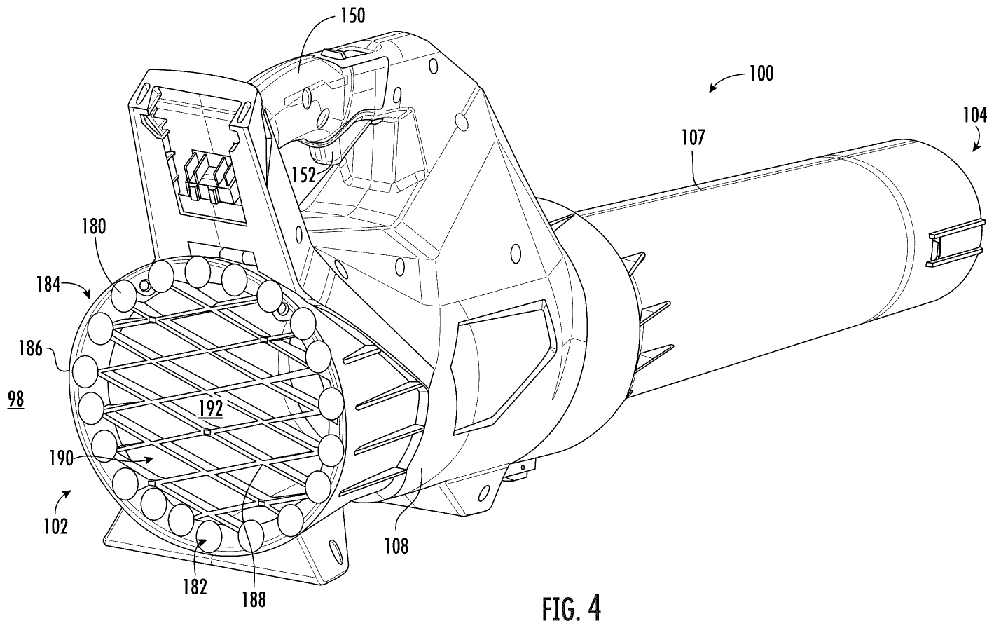

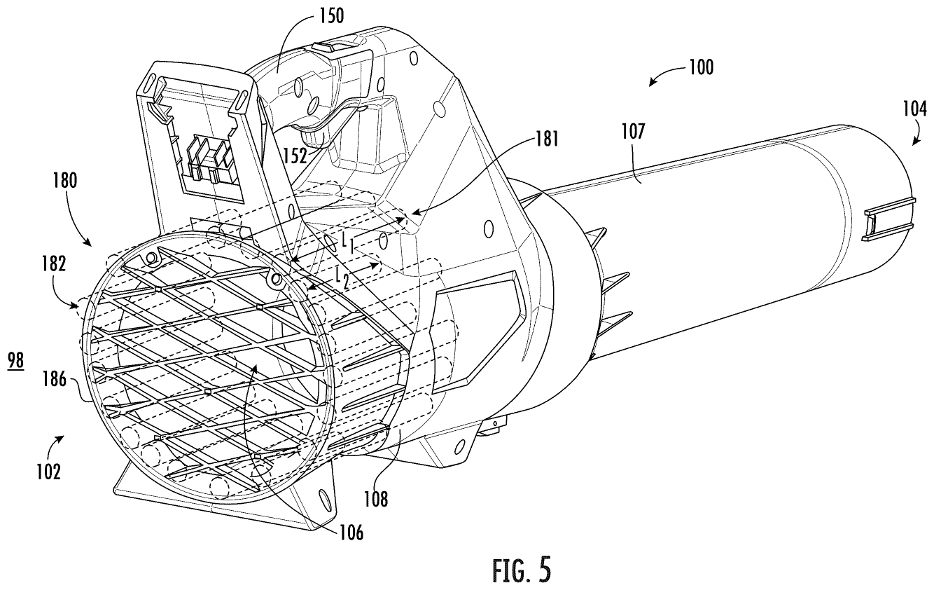

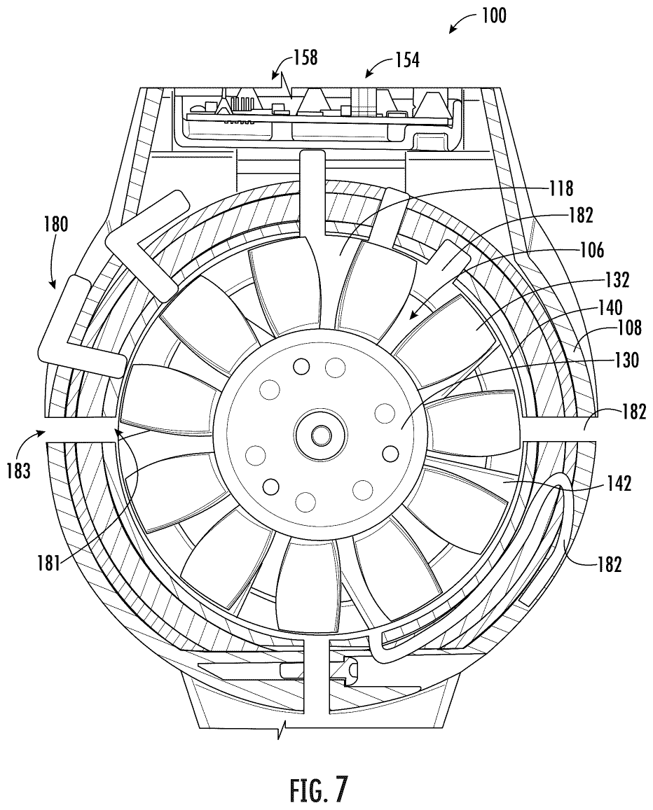

Referring now to FIGS. 4-5, a perspective view and a partially transparent perspective view of an embodiment of the blower 100 are provided. Blower 100 includes a resonator device 180 having a plurality of passages 182 extending in fluid communication from the conduit 106. In various embodiments, such as depicted in FIGS. 4-6, the plurality of passages 182 extend substantially co-directional to extension of the conduit 106 at the inlet portion 102. For instance, the plurality of passages 182 extend substantially axially along the conduit 106. Referring to the cross sectional conduit flowpath view provided of an embodiment at the inlet portion 102 provided in FIG. 7, the plurality of passages 182 extend substantially radially or perpendicular from the conduit 106 at the inlet portion 102.

The plurality of passages 182 have a length extending from the conduit 106. The length corresponds to a quarter wavelength or a half wavelength relative to a frequency of the fan 112 or the motor 114 when inducing the flow of air through the conduit 106. For instance, a first passage includes a first length L₁ corresponding to a first target frequency generated from the airflow generation assembly 110. A second passage includes a second length L₂ corresponding to a second target frequency generated from the airflow generation assembly 110.

Referring to FIG. 5, the inlet portion 102 includes an end portion 186 forming an inlet opening into the conduit 106. Various embodiments of the end portion 186 may include a grate 188 through which air enters the inlet portion 102. Grate 188 may include a plurality of polygonal cells 190 forming openings 192 across which air flows. Grate 188 may include noise attenuating metamaterials and structures, such as described in regard to resonator structure 160.

The plurality of passages 182 is positioned through an outer perimeter 184 of the end portion 186 of the inlet portion 102. The plurality of passages 182 is positioned in adjacent circumferential arrangement along the end portion 186, such as in adjacent circumferential arrangement around the conduit 106.

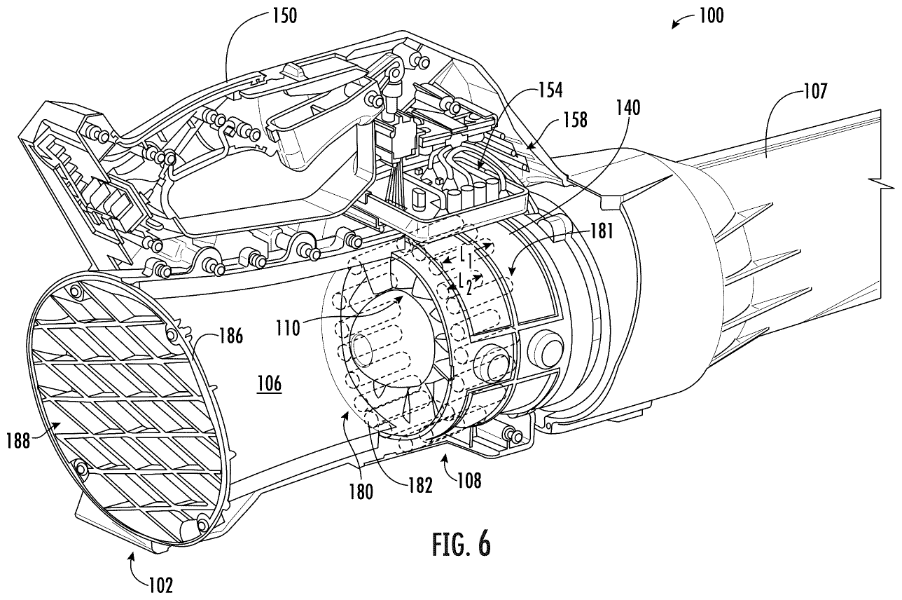

Referring to FIG. 6, the plurality of passages 182 extends through the shroud 140 surrounding the airflow generation assembly 110. The plurality of passages 182 is positioned in adjacent circumferential arrangement through the shroud 140, such as around the plurality of stator vanes 142, the fan 112, the motor 114, all thereof, or portions thereof.

Referring to FIG. 7, the plurality of passage 182 extends at least partially radially through the shroud 140 surrounding the airflow generation assembly 110. For instance, an open end 181 of the passages 182 is positioned through the shroud 140 in fluid communication with the conduit 106 and the passage 182 extends substantially radially from the open end.

Referring to FIGS. 4-7, in various embodiments, the passages 182 each include at least one open end 181 in direct or indirect fluid communication with the conduit 106. In some embodiments, at least a portion of the plurality of passages 182 includes a length corresponding to a quarter wavelength and having a closed end opposite of the open end 181. In still some embodiments, at least a portion of the plurality of passages 182 includes a length corresponding to a half wavelength and having an open end opposite of the open end 181 in fluid communication with the conduit 106. Although depicted as substantially straight passages 182, in various embodiments (see, e.g., FIG. 7), passages 182 may include straight, curved, hooked, serpentine, or labyrinthine passages, or combinations thereof. Passages 182 may extend at least partially along a circumferential direction around the conduit 106 through shroud 140, blower housing 108, or both.

Referring back to FIG. 4, in some embodiments, a second open end opposite of a first open end in fluid communication with the conduit 106 provides fluid communication of at least a portion of the plurality of passages 182 to a volume 98 outside of the conduit 106 (e.g., an outside or atmospheric volume). For instance, the open end of the portion of the plurality of passages 182 (e.g., opposite of open end 181) is positioned through perimeter 184 of end portion 186 of the inlet portion 102. Referring to FIG. 6, in still some embodiments, at least a portion of the plurality of passages 182 includes open end 181 and an opposing open end of the respective passage 182 each positioned in direct fluid communication at the conduit 106.

It should be appreciated that passages 182 depicted in FIGS. 4-7 may include closed ends, or combinations of open and closed ends, at one or more of the plurality of passages 182. As such, various embodiments of the plurality of passages 182 may be configured entirely as having an open end and a closed end, or entirely as having a pair of open ends, or combinations thereof.

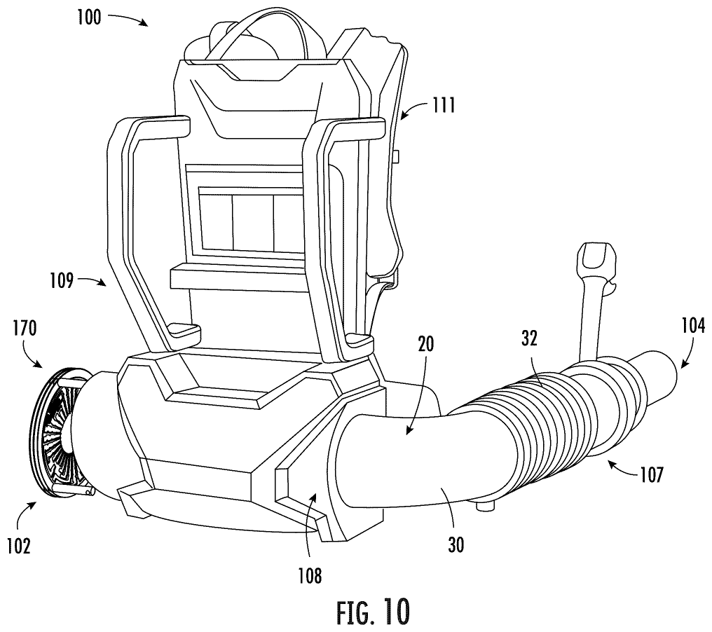

Referring now to FIG. 10, another embodiment of blower 100 in accordance with aspects of the present disclosure is provided. As illustrated, blower 100 has a backpack unit 109 and configured to carry blower housing 108, such as described in regard to FIGS. 1-2. While the blower 10 illustrated in FIG. 10 is a backpack blower configured to be worn on a user's back, e.g., with backpack supports 111, the features of the present invention may be implemented for a handheld blower (such as, for example, illustrated in FIGS. 1 and 2), e.g., a handheld axial fan blower or a centrifugal fan blower.

Airflow conduit 106 extends from air inlet portion 102 to air outlet portion 104. The airflow conduit 106 may be formed by blower housing 108 and/or blower tube 107. For instance, the blower housing 108 may define the air inlet portion 102 at one end thereof. The blower housing 108 may be coupled, directly or indirectly, with the blower tube 107 at an opposite end relative to the air inlet 22. For instance, an elbow tube 30 may be provided between the blower housing 108 and the blower tube 107 as shown in FIG. 10. In some embodiments, a bellows 32 may be provided between the blower housing 108 and the blower tube 107, e.g., to facilitate the blower tube 107 to pivotably move and/or rotate relative to the blower housing 108.

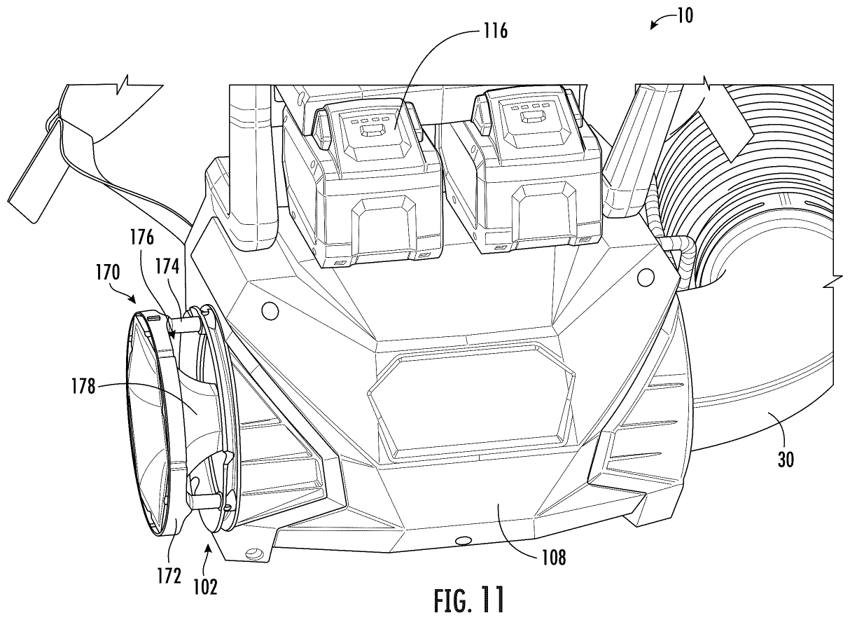

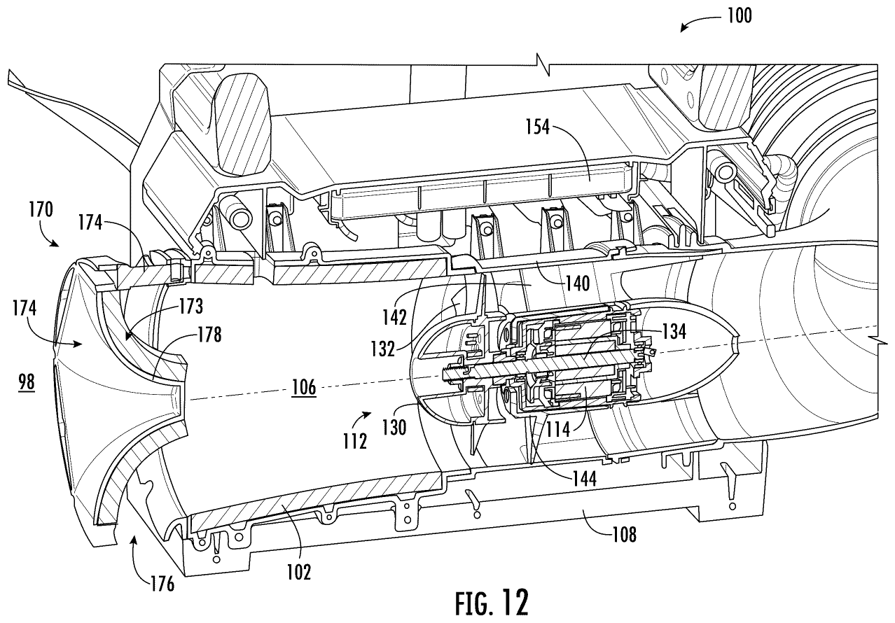

Referring now to FIG. 11, a perspective view of an embodiment of the blower 100 of FIG. 10 is provided. FIG. 12 provides a cutaway view of the embodiment of FIG. 11. A muffler assembly 170 is coupled to the inlet portion 102. The muffler assembly 170 includes a muffler wall 172. A mount member 174 extends from the inlet portion 102 to the muffler wall 172 to form an inlet gap 176 therebetween. For instance, the mount member 174 extends co-directional to an extension of the conduit 106 (e.g., extending axially from the conduit 106). The muffler wall 172 is spaced apart co-directionally from the inlet portion 102 and obscures the conduit 106 along a direction of extension of the conduit 106. As such, the muffler assembly 170 may prevent view and entry of objects into the conduit 106 along the direction of extension of the conduit 106 (e.g., along the axial direction).

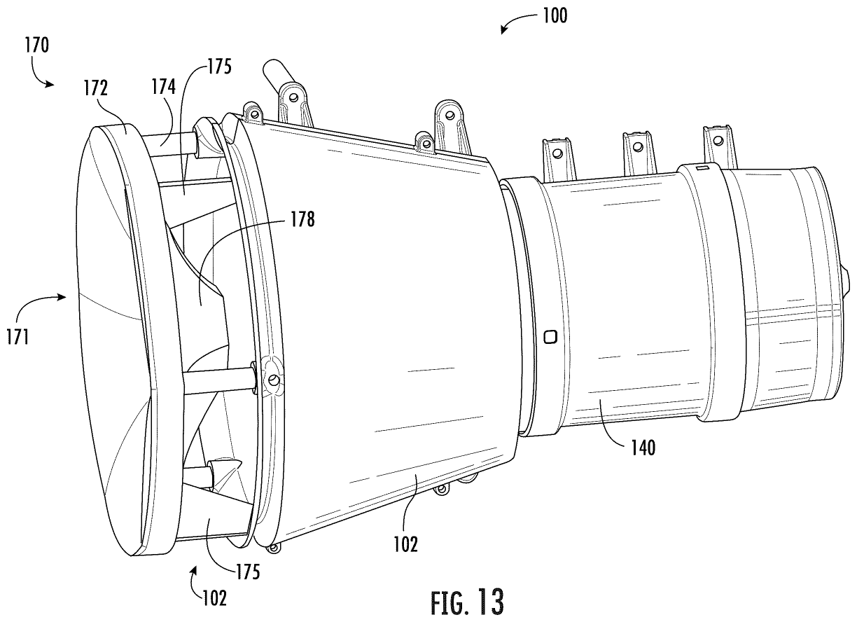

The muffler wall 172 spaced apart co-directionally from the inlet portion 102 forms the inlet gap 176 as a radial pathway along which air flows into the conduit 106. The inlet gap 176 extends at least partially circumferentially relative to a centerline axis of the conduit 106. For instance, the inlet gap 176 may form a substantially circumferential opening except for the mount members 174 extending between the muffler wall 172 and the blower housing 108. Referring briefly to FIG. 13, in some embodiments, the muffler assembly 170 includes a fin or vane 175 extending between the inner portion 102 and the muffler wall 172. The vane 175 forms a stationary airfoil, such as may condition airflow into the conduit 106, form a non-annular opening or inlet gap 176, or provide structural rigidity, support, and impact durability for the muffler wall 172. For instance, muffler assembly 170 may include a plurality of vanes 175, such as three (3) or more vanes.

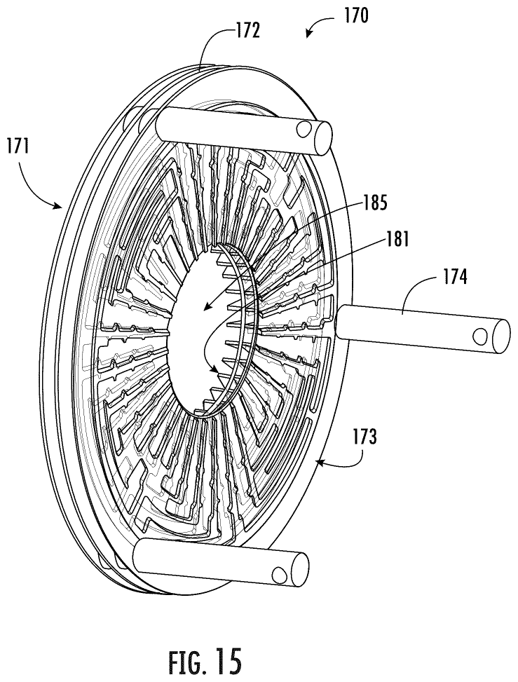

Referring to FIGS. 11-14, the muffler wall 172 extends substantially perpendicular or radially relative to a centerline axis of the conduit 106. In various embodiments, the muffler wall 172 includes a curved portion 178 extending toward the conduit 106. The curved portion 178 reflects sound energy back into the blower 100, such as back into the conduit 106. In various embodiments, the curved portion 178 forms a concave portion extending toward or into the conduit 106. In some embodiments, the curved portion 178 includes a convex surface, or a substantially flat surface, such as further depicted and described in regard to FIGS. 15-17.

In various embodiments, the muffler wall 172 includes an outer wall 171 facing the outside volume 98, and an inner wall 173 facing the conduit 106. The inner wall 173 may include an air-permeable membrane positioned proximate to or extending into the conduit 106, For instance, the inner wall 173 including the curved portion 178 may include the air-permeable membrane, such as a foam lining, or one or more acoustic attenuating foam layers. The inner wall 173 including the membrane may facilitate attenuation of low frequency acoustic noise. Mount member 174 may facilitate extending the muffler wall 172 from the inlet portion 102 such as to extend the inlet gap 176 sufficiently to allow for layers or thicknesses of inner wall 173 including the membrane to facilitate low frequency noise and disrupt relative long wavelengths.

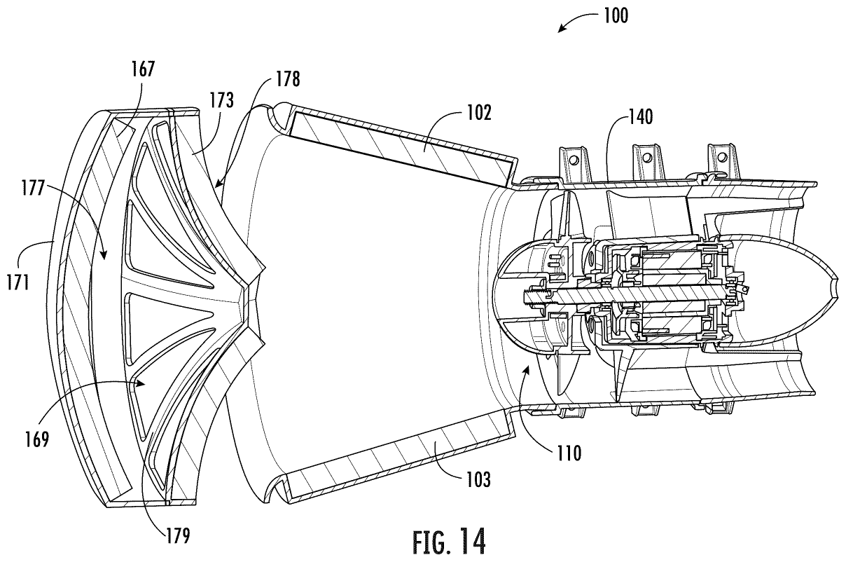

Referring to FIG. 14, a cross sectional view of the portion of the blower 100 of FIG. 13 is provided. The outer wall 171 and the inner wall 173 are spaced apart from one another to form a muffler chamber 177 therebetween. The muffler wall 172 may include a radially extended rib 179 forming a gap 169 between pairs of ribs 179. The gap 169 allows fluid communication between the ribs 179 into the muffler chamber 177. Inner wall 173 including the air-permeable membrane or foam layer allows fluid communication from the conduit 106 into the muffler chamber 177 through the inner wall 173 and gap 169. In still various embodiments, the outer wall 171 includes a noise attenuating foam layer 167 at the muffler chamber 177. The muffler chamber 177 formed from the gap between the inner and outer walls 171, 173 downstream of noise attenuating layers may increase the disruptiveness of high amplitude portions of long wavelength noise (e.g., low frequency sound waves).

As such, various embodiments of the muffler assembly 170 may include sound attenuating layers at the inner wall 173 and the outer wall 171. Noise attenuation may additionally, or alternatively, be facilitated with the curved portion 178 of the muffler wall 172, the muffler chamber 177, or both.

In still some embodiments, the inlet portion 102 may include a sound attenuating layer 103 extending from the inlet opening to the airflow generation assembly 110. As such, combinations of the muffler assembly 170 and inlet portion 102 may include one or more layers of noise attenuating material, such as may reduce sound perceived by a user.

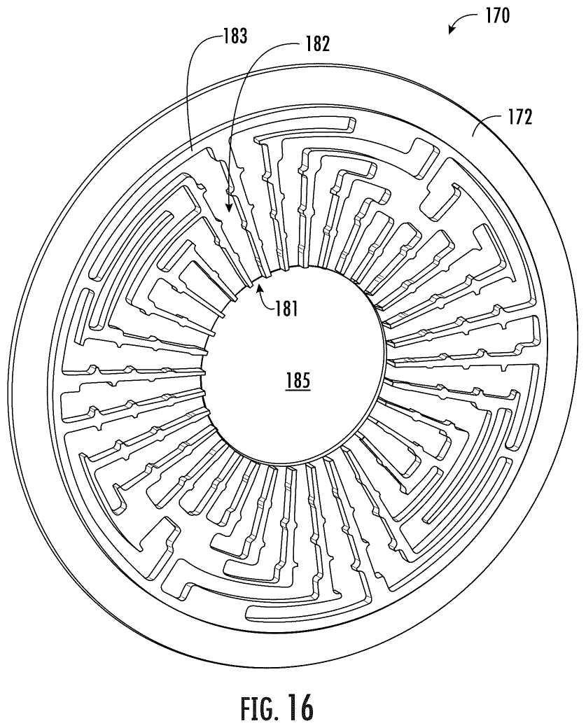

Referring now to FIGS. 15-17, embodiments of muffler assembly 170 are provided. Muffler wall 172 extends substantially radially or perpendicular to a centerline axis of the conduit 106. Referring to FIGS. 15-16, muffler assembly 170 includes outer wall 171 and inner wall 173. A center plenum 185 is formed at which one or more resonator passages 182 has an open end 181, such as described in regard to FIGS. 4-7. Passages 182 are formed between the outer wall 171 and the inner wall 173. For instance, passages 182 may extend substantially radially, or additionally, form labyrinthine, serpentine, or circumferentially-extending passages. Passages 182 may be configured as quarter wavelength passages having a closed end 183. Additionally, or alternatively, passages 182 may be configured as half wavelength passages having a pair of open ends radially separated from one another.

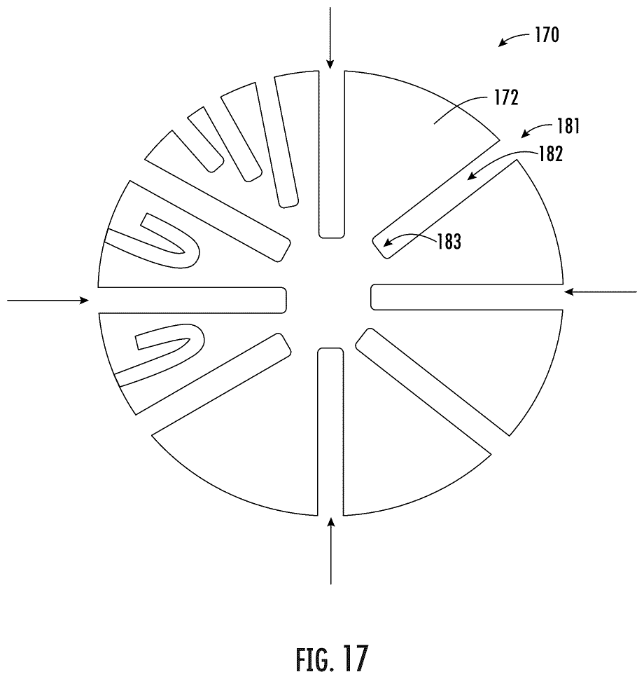

Referring to FIGS. 15-16, passages 182 may extend substantially radially outward from open end 181. Referring to FIG. 17, passages 182 may extend substantially radially inward from open end 181.

Embodiments of the muffler assembly 170 forming the inlet gap 176 may form a grate-less inlet assembly of the blower 100 that may improve aerodynamic efficiency.

Various embodiments of the blower 100 may include a sensor configured to detect an object at the inlet portion of the conduit. Embodiments of the sensor may include a light sensor, a capacitive sensor, or an inductive sensor.

Embodiments of the light sensor may include a light source and configured as a break-beam or reflected-beam light sensor. The light sensor may include visible light, infrared (IR) light, or other spectrums of light. The light sensor may be configured as a photodiode, photoresistor, or other appropriate configuration of light sensor for detecting an object at the inlet gap 176 or conduit 106 at the inlet portion 102.

Embodiments of the blower 100 including the sensor are operably coupled to the controller 154 to inhibit turning the blower on if an object is inserted in the inlet gap 176 or conduit 106 at the inlet portion 102. For instance, controller 154 may include a firmware routine configured to activate a braking mechanism at the airflow generation assembly 110 or inhibit activation of the airflow generation assembly 110 when an object is inserted at the inlet gap 176 or conduit 106 at the inlet portion 102.

In various embodiments, the sensor may be positioned at the mount member 174, central plenum 185, fin or vane 175, or curved portion 178 of the muffler assembly 170 to determine presence of an object at the inlet gap 176 or conduit 106 at the inlet portion 102.

In still various embodiments, the sensor may be positioned at the inlet portion 102. For instance, the sensor may be positioned at least partially through opening 161. Transmission structures (e.g., wires) may extend through plenum 158 to controller 154, such as may communicate signals from the sensor to controller 154 and airflow generation assembly 110 for stopping or inhibiting operation of the airflow generation assembly 110 when the sensor detects an object at the inlet gap 176 or conduit 106.

Further aspects of the disclosure are provided in one or more of the following clauses:

1. A blower, including a conduit extending along a flowpath extending between an inlet portion and an outlet portion; an airflow generation assembly positioned between the inlet portion and the outlet portion, the airflow generation assembly configured to induce a flow of air along the flowpath from the inlet portion through the outlet portion, wherein the inlet portion includes a resonator device including a plurality of passages extending in fluid communication from the flowpath.

2. The blower of any one or more clauses herein, wherein the plurality of passages extend substantially co-directional to extension of the flowpath.

3. The blower of any one or more clauses herein, wherein at least a portion of the plurality of passages includes a closed end.

4. The blower of any one or more clauses herein, wherein at least a portion of the plurality of passages includes an open end, wherein the open end provides fluid communication of the portion of the plurality of passages to a volume outside of the conduit.

5. The blower of any one or more clauses herein, wherein the open end of the portion of the plurality of passages is positioned through a perimeter of an end portion of the inlet portion.

6. The blower of any one or more clauses herein, wherein at least a portion of the plurality of passages includes a pair of open ends each in fluid communication with the flowpath.

7. The blower of any one or more clauses herein, wherein the airflow generation assembly includes a fan and a motor configured to drive the fan to induce the flow of air through the flowpath, and wherein the plurality of passages includes a length extending from the flowpath, wherein the length corresponds to a quarter wavelength or a half wavelength relative to a frequency of the fan or the motor when inducing the flow of air through the flowpath.

8. The blower of any one or more clauses herein, wherein the plurality of passages extends substantially co-directional to extension of the flowpath.

9. The blower of any one or more clauses herein, wherein the plurality of passages extends substantially perpendicular to extension of the flowpath.

10. The blower of any one or more clauses herein, wherein the airflow generation assembly includes a plurality of stator vanes, wherein the plurality of passages is positioned in adjacent circumferential arrangement around the plurality of stator vanes.

11. The blower of any one or more clauses herein, wherein the inlet portion includes an end portion including a grate through which air enters the inlet portion.

12. The blower of any one or more clauses herein, wherein the grate includes a plurality of polygonal cells forming openings across which air flows.

13. The blower of any one or more clauses herein, including a blower housing at which the airflow generation assembly is positioned between the inlet portion and the outlet portion, the blower housing including a plenum at which a resonator structure is positioned.

14. The blower of any one or more clauses herein, wherein the plenum is positioned radially between a handle and the conduit.

15. The blower of any one or more clauses herein, including a muffler assembly coupled to the inlet portion, the muffler assembly including a muffler wall and a mount member extending from the inlet portion to the muffler wall to form an inlet gap therebetween.

16. The blower of any one or more clauses herein, wherein the mount member extends co-directional to an extension of the conduit, and wherein the muffler wall is spaced apart co-directionally from the inlet portion and obscures the conduit along a direction of extension of the conduit.

17. The blower of any one or more clauses herein, wherein the muffler wall spaced apart co-directionally from the inlet portion forms the inlet gap as a radial pathway along which air flows into the conduit.

18. The blower of any one or more clauses herein, wherein the muffler wall spaced apart co-directionally from the inlet portion forms the inlet gap extending at least partially circumferentially relative to a centerline axis of the conduit.

19. The blower of any one or more clauses herein, wherein the muffler wall extends substantially perpendicular to a centerline axis of the conduit.

20. The blower of any one or more clauses herein, wherein the muffler wall extends radially relative to a centerline axis of the conduit, and wherein the muffler wall includes a curved portion extending toward the conduit.

21. The blower of any one or more clauses herein, wherein the muffler wall includes an outer wall, an inner wall forming an air-permeable membrane positioned proximate to the conduit, and a muffler chamber positioned therebetween, wherein the muffler chamber is in fluid communication with the conduit through the air-permeable membrane.

22. The blower of any one or more clauses herein, wherein the muffler wall includes a radially extended rib supporting the air-permeable membrane of the inner wall.

23. The blower of any one or more clauses herein, wherein the air-permeable membrane includes a foam layer.

24. The blower of any one or more clauses herein, wherein the muffler assembly includes a vane extending between the inner portion and the muffler wall.

25. The blower of any one or more clauses herein, wherein the muffler wall includes an outer wall, an inner wall, and a plurality of resonator passages extending radially relative to a centerline axis.

26. The blower of any one or more clauses herein, wherein the muffler wall includes a center plenum in fluid communication with the conduit, and wherein the plurality of resonator passages includes an open end at the center plenum.

27. The blower of any one or more clauses herein, wherein at least a portion of the plurality of resonator passages includes a closed end radially outward of the open end.

28. The blower of any one or more clauses herein, wherein the muffler wall includes an open end positioned radially outward of a closed end.

29. The blower of any one or more clauses herein, including a sensor configured to detect an object at the inlet portion of the conduit.

30. The blower of any one or more clauses herein, wherein the sensor is configured as a light-based sensor.

31. The blower of any one or more clauses herein, wherein the sensor is configured as a capacitive sensor.

32. The blower of any one or more clauses herein, wherein the sensor is configured as an inductive sensor.

33. A blower, including a conduit extending along a flowpath extending between an inlet portion and an outlet portion; an airflow generation assembly positioned between the inlet portion and the outlet portion, the airflow generation assembly configured to induce a flow of air along the flowpath from the inlet portion through the outlet portion; a muffler assembly coupled to the inlet portion, the muffler assembly including a muffler wall and a mount member extending from the inlet portion to the muffler wall to form an inlet gap therebetween.

34. The blower of any one or more clauses herein, wherein the mount member extends co-directional to an extension of the conduit, and wherein the muffler wall is spaced apart co-directionally from the inlet portion and obscures the conduit along a direction of extension of the conduit.

35. The blower of any one or more clauses herein, wherein the muffler wall spaced apart co-directionally from the inlet portion forms the inlet gap as a radial pathway along which air flows into the conduit.

36. The blower of any one or more clauses herein, wherein the muffler wall spaced apart co-directionally from the inlet portion forms the inlet gap extending at least partially circumferentially relative to a centerline axis of the conduit.

37. The blower of any one or more clauses herein, wherein the muffler wall extends substantially perpendicular to a centerline axis of the conduit.

38. The blower of any one or more clauses herein, wherein the muffler wall extends radially relative to a centerline axis of the conduit, and wherein the muffler wall includes a curved portion extending toward the conduit.

39. The blower of any one or more clauses herein, wherein the muffler wall includes an outer wall, an inner wall forming an air-permeable membrane positioned proximate to the conduit, and a muffler chamber positioned therebetween, wherein the muffler chamber is in fluid communication with the conduit through the air-permeable membrane.

40. The blower of any one or more clauses herein, wherein the muffler wall includes a radially extended rib supporting the air-permeable membrane of the inner wall.

41. The blower of any one or more clauses herein, wherein the air-permeable membrane includes a foam layer.

42. The blower of any one or more clauses herein, wherein the muffler assembly includes a vane extending between the inner portion and the muffler wall.

43. The blower of any one or more clauses herein, wherein the muffler wall includes an outer wall, an inner wall, and a plurality of resonator passages extending radially relative to a centerline axis.

44. The blower of any one or more clauses herein, wherein the muffler wall includes a center plenum in fluid communication with the conduit, and wherein the plurality of resonator passages includes an open end at the center plenum.

45. The blower of any one or more clauses herein, wherein at least a portion of the plurality of resonator passages includes a closed end radially outward of the open end.

46. The blower of any one or more clauses herein, wherein the muffler wall includes an open end positioned radially outward of a closed end.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A blower, comprising:
a conduit extending along a flowpath extending between an inlet portion and an outlet portion;
an airflow generation assembly positioned between the inlet portion and the outlet portion, the airflow generation assembly configured to induce a flow of air along the flowpath from the inlet portion through the outlet portion;
a muffler assembly coupled to the inlet portion, the muffler assembly comprising a muffler wall and a mount member extending from the inlet portion to the muffler wall to form an inlet gap therebetween.

2. The blower of claim 1, wherein the mount member extends co-directional to an extension of the conduit, and wherein the muffler wall is spaced apart co-directionally from the inlet portion and obscures the conduit along a direction of extension of the conduit.

3. The blower of claim 2, wherein the muffler wall spaced apart co-directionally from the inlet portion forms the inlet gap as a radial pathway along which air flows into the conduit.

4. The blower of claim 2, wherein the muffler wall spaced apart co-directionally from the inlet portion forms the inlet gap extending at least partially circumferentially relative to a centerline axis of the conduit.

5. The blower of claim 1, wherein the muffler wall extends substantially perpendicular to a centerline axis of the conduit.

6. The blower of claim 1, wherein the muffler wall extends radially relative to a centerline axis of the conduit, and wherein the muffler wall comprises a curved portion extending toward the conduit.

7. The blower of claim 1, wherein the muffler wall comprises an outer wall, an inner wall forming an air-permeable membrane positioned proximate to the conduit, and a muffler chamber positioned therebetween, wherein the muffler chamber is in fluid communication with the conduit through the air-permeable membrane.

8. The blower of claim 7, wherein the muffler wall comprises a radially extended rib supporting the air-permeable membrane of the inner wall.

9. The blower of claim 8, wherein the air-permeable membrane comprises a foam layer.

10. The blower of claim 1, wherein the muffler assembly comprises a vane extending between the inner portion and the muffler wall.

11. The blower of claim 1, wherein the muffler wall comprises an outer wall, an inner wall, and a plurality of resonator passages extending radially relative to a centerline axis.

12. The blower of claim 11, wherein the muffler wall comprises a center plenum in fluid communication with the conduit, and wherein the plurality of resonator passages comprises an open end at the center plenum.

13. The blower of claim 12, wherein at least a portion of the plurality of resonator passages comprises a closed end radially outward of the open end.

14. The blower of claim 11, wherein the muffler wall comprises an open end positioned radially outward of a closed end.

15. The blower of claim 11, wherein the plurality of passages comprises a length extending from the flowpath, wherein the length corresponds to a quarter wavelength or a half wavelength relative to a frequency of the fan or the motor when inducing the flow of air through the flowpath.

16. The blower of claim 11, wherein the plurality of resonator passages formed between the outer wall and the inner wall extend radially and form labyrinthine, serpentine, or circumferentially-extending passages.

17. The blower of claim 16, wherein the plurality of resonator passages comprise a closed end configuring the plurality of resonator passages as quarter wavelength passages.

18. The blower of claim 1, wherein the muffler assembly comprising the inlet gap comprises a grate-less inlet assembly.

19. The blower of claim 1, wherein the blower is configured as a backpack blower comprising a backpack unit configured to carry a blower housing at which the airflow generation assembly is positioned.

20. The blower of claim 1, wherein the blower is configured as an axial fan blower or centrifugal fan blower.
